(19) United States
(12) Patent Application Publication
(10) Pub. No.: US 2007/0082616 A1
(43) Pub. Date: Apr. 12, 2007

(54) Interference-based routing in a wireless network

(76) Inventor: Neil C. Bird, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,399

(22) PCT Filed: Feb. 11, 2004
(86) PCT No.: PCT/IB04/00445

§ 371 Date: Nov. 21, 2006

(30) Foreign Application Priority Data
Feb. 25, 2003 (GB) 0304216.5

(51) Int. Cl. H04B 1/00

(52) U.S. Cl. 455/63.1

(57) ABSTRACT

A wireless network comprising nodes uses measurement or prediction of interference at the nodes to select a route for a message through the network that results in acceptable amounts of interference. The interference may be caused to the message by other traffic carried by the network or by other networks, in which case the amount of interference to the nodes on the selected route must be acceptable, or may be caused to the other traffic by the message being routed, in which case, the amount of interference to the nodes outside of the selected route must be acceptable.

The invention relates to a wireless network, nodes for use in a wireless network, and a method of operating a wireless network.

A wireless network comprises a plurality of nodes equipped with wireless transceivers. Such a network may be used, for example, in a domestic or office environment with the nodes being, or forming part of, objects such as light switches, heating controls and security sensors for monitoring and control purposes, or audio, video and computer equipment for distributing and collecting data.

In a wireless network, data is transported in messages which are transmitted from a source node to a destination node either directly, where the source and destination nodes can receive signals directly from each other, or routed via one or more intermediate nodes where the source and destination nodes cannot receive signals directly from each other.

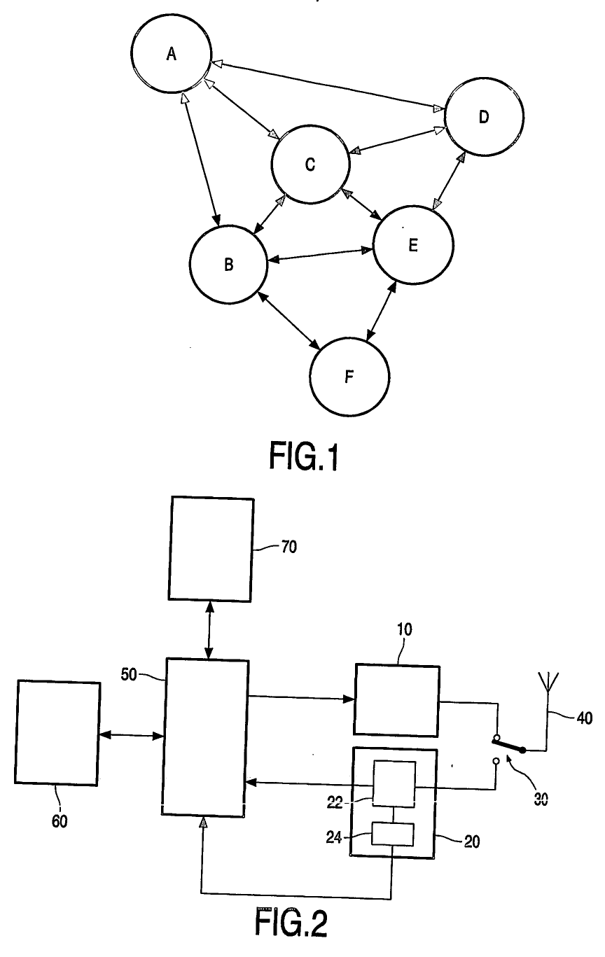

An example wireless network is illustrated in FIG. 1 and comprises six nodes A to F. The arrows represent paths of direct communication between the nodes. Node C, for example, can communicate directly with nodes A, B, D and E, but cannot communicate directly with node F. Node A, for example, can communicate directly with nodes B, C and D, but cannot communicate directly with nodes E or F. Communication between node A and nodes E or F must be via one or more intermediate nodes, B, C, or D.

By using intermediate nodes, it is possible for the transmit power and receiver sensitivity of the nodes to be kept low, rather than provide sufficient power and sensitivity to enable direct communication between any two nodes. The amount of power that needs to be transmitted is proportional to dⁿ, where d is the distance to be covered and n is typically between 2 and 4, and so the total power can be reduced by more than an order of magnitude if several hops are used instead of direct communication.

In general, there will be more than one possible route for a message between the source and destination nodes and a routing criterion is used to select a route. In the network of FIG. 1, a message generated by node A and destined for node F has a choice of many routes including, for example, ABF, ACBF, ACEF, ADEF. Some criteria for selecting a route are: shortest distance; lowest power consumption; least number of hops; and balancing the traffic handled by each node.

As wireless networks become more widespread and the amount of signalling carried by wireless networks increases, and the type of data changes, performance will become increasingly dependent on the routing criterion and performance may be improved by devising new routing criteria.

An object of the present invention is to improve the performance of a wireless network.

According to a first aspect of the invention there is provided a method of selecting a route for a message in a wireless network comprising a plurality of nodes, the method comprising determining for each of at least some of the nodes an indication of an amount of interference experienced by that node and selecting a route having one or more nodes and which provides compliance of the indication of the amount of interference experienced by a subset of the nodes with a predetermined criterion.

According to a second aspect of the invention there is provided a primary node for use in a wireless network comprising a plurality of nodes, the primary node comprising a transceiver for transmitting and receiving messages, processing means for encoding messages prior to transmission and for decoding received messages, storage means for storing an indication of an amount of interference experienced by each of at least some of the nodes, and selection means for selecting for a message prior to transmission a route having one or nodes and which provides compliance of the indication of the amount of interference experienced by a subset of the nodes with a predetermined criterion.

According to a third aspect of the invention there is provided a secondary node for use in a wireless network comprising a plurality of nodes, the secondary node comprising a transceiver for transmitting and receiving messages, processing means for encoding messages prior to transmission and for decoding received messages, measurement means for measuring an amount of interference and transmitter means for transmitting an indication of the amount of interference.

According to a fourth aspect of the invention there is provided a wireless network comprising at least one primary node in accordance with the second aspect of the invention.

By taking account of any interference experienced by nodes, either as a sole criterion or in conjunction with known route selection criteria, the performance of the network can be improved by avoiding routing via those nodes suffering the worst interference, or by avoiding routing via those nodes likely to cause the worst interference. The interference at each node can be either interference that may degrade the performance of the message for which the route is selected, or interference that may be caused to other message traffic by the message for which the route is selected, or a combination of both. The amount of interference at each node can be either predicted, or measured, for interference existing prior to transmission of the message, or a combination of both.

The invention will now be described, by way of example only, with reference to the accompanying drawings wherein:

FIG. 1 is a diagrammatic representation of a wireless network, and

FIG. 2 is a block schematic diagram of a node.

Consider a wireless network as illustrated in FIG. 1 and the case of a message that is to be routed from node A, the source node, to node F, the destination node. If the criterion for selecting the route is the fewest number of hops, then the optimum route is ABF. If load distribution is used as the selection criterion and nodes B and C are busy transferring data between themselves, the optimum route is ADEF. However, if, in accordance with the invention, RF interference levels are considered in the selection criterion, a different route may be optimum. For example, the proximity of node C to node D may result in a high level of interference at node D from node C and consequently a poor performance in transmitting the message via route ADEF. The poor performance may be manifest as a low probability of success and/or a low throughput due to a high number of retransmissions. Taking the level of interference into account, a better probability of success or a better throughput may be achieved by selecting route ACEF even though node C has other messages to transmit.

The routing decision may be based solely on the amount of interference at one or more nodes, or may include additional factors such as those known factors listed above.

The amount of RF interference experienced at a node due to message traffic within the network may be predicted by a node that has access to information about the network traffic, such as a master node which knows the amount of message traffic and its destinations. Alternatively, nodes may report to the decision making node an indication of the amount of RF interference they are experiencing. Such a report may be based on a measurement of received signals. An advantage of measuring the amount of interference is that sources of interference external to the network can be accounted for. For example, in FIG. 1, if node E is experiencing a high level of interference from a source external to the network, route ACEF may result in a poor performance, and a better route may be ACBF or ABF, even though nodes B and C are busy.

The routing criterion can take into account the interference caused to the message by other messages within or outside of the network, as in the examples above, but alternatively, or in addition, the routing criterion can take into account the interference that will be caused to other messages by the message for which a route is to be selected. For example, in FIG. 1, a message routed ACEF may cause interference to nodes B and D, whereas the route ADEF may be preferable, taking the message further from node B and therefore reducing the likelihood of interference to node B.

Various addressing methods may be used in conjunction with the invention. Some examples are as follows.

The route for a message may be defined by the source node, in which case the source node inserts into the message prior to transmission a list of the addresses of the nodes in the route, and as the message reaches each intermediate node, that intermediate node removes its own address from the message and forwards the message to the node having the next address in the route list.

Another example of addressing, is applicable to a network which includes a master node and slave nodes, with all messages passing through the master node. In this case the route comprises two legs. First the source node inserts into the message the required addresses to route the message from the source node to the master node, and then the master inserts the required addresses to route the message onwards to the destination node.

As a further example of addressing, the route may be determined one hop at a time, with each node deciding the optimum next node to transmit the message to, for example the node experiencing lowest interference. Intermediate nodes replace their own address in the message with the address of their selected next node.

FIG. 2 illustrates a block schematic diagram of a node. There is a wireless transceiver comprising a transmitter 10 and a receiver 20 which are both coupled to an antenna 40 by means of a changeover switch 30. The receiver 20 comprises a receiver stage 22 which converts a signal received from the antenna to baseband, and which is coupled to deliver the baseband signal to a processing means 50. The receiver 20 also comprises a received signal level indicator (RSSI) 24 which measures the level of the signal received by the receiver stage 22 and delivers the measurement result to the processing means 50. The processing means 50 is coupled to a storage means 60 and to an application 70 that sends and receives messages via the processing means 50, transmitter 10 and receiver 20. Examples of an application 70 are: a lighting control; a heating control; a security sensor or control; audio player or storage medium; or video players or storage medium.

The operation of the node of FIG. 2 is as follows. In an idle state, when the node is neither transmitting nor receiving a message, the RSSI 24 measures the received level of RF interference and the processing means 50 generates an indication of the amount of interference, if any, which is then transmitted by means of the transmitter 10 to inform other nodes of the interference level at that node. The indication of the amount of interference may be dependent on the amplitude of the interference and/or the time duration of the interference. The times at which these interference reports are transmitted may be predetermined, or transmission may be in response to a request from another node, or in response to the interference exceeding a predetermined level.

When the processing means 50 receives an interference report indicating the amount of interference at another node, it stores the indication in the storage means 60 together with the address of the node originating the report. After a period of time the store will contain interference reports from many or all of the nodes in the network.

When the application 70 has a requirement to transmit a message to another node, it delivers the message to the processing means 50. The processing means 50 then retrieves the interference reports from the storage means 60 and uses the indications of the amount of interference at other nodes to select a route for the message. Any desired selection criterion which takes into account the interference may be used. Some example criteria are as follows: the highest amount of interference experienced at any individual intermediate node is minimised; or the amount of interference at each intermediate node is lower than a predetermined threshold; or the duration of interference at any individual intermediate node is shorter than a predetermined value; or overall bit error rate is minimised; or a quality parameter such as message success rate or throughput is maximised. Optionally the selection criterion may take account of the duration of the interference and the duration of the message to be transmitted; for example a continuous but low level of interference may be regarded as more detrimental to a long message, for example streamed audio visual information, than short bursts of a higher level of interference as the short bursts may be compensated for by error correction coding.

Having selected a route, the processing means 50 encodes the message for transmission, adding fields such as a synchronisation word, a header and error check data, and including the addresses required for routing. The formatted message is then transferred to the transmitter 10 for transmission via the antenna 40.

In an alternative embodiment, the processing means 50 predicts, using available information relating to the other nodes such as received signal strength or amount of traffic carried, the amount of interference that transmission of a message by available alternative routes would cause to other nodes. The processing means then stores in the storage means 60 an indication of the predicted amount of interference to each node for each available route. Then, when the application 70 requires to transmit a message, the processing means 50 refers to the storage means 60 and selects the optimum route. Any desired selection criterion which takes into account the interference caused by the message being routed may be used. Some example criteria are as follows: the highest amount of interference experienced at any node outside the selected route is minimised; or the amount of interference at each node outside the selected route is lower than a predetermined threshold; or the duration of interference at any node outside the selected route is shorter than a predetermined value; or overall bit error rate at nodes outside of the selected route is minimised; or a quality parameter such as message success rate or throughput is maximised at nodes outside the selected route. Optionally the selection criterion may take account of the duration of the interference caused by the message and the duration of other message traffic in the network; for example a continuous but low level of interference may be regarded as more detrimental to a long messages, for example streamed audiovisual data, than short bursts of a higher level of interference as the short bursts may be compensated for by error correction coding.

The data stored in the storage means 60 is updated at appropriate intervals to ensure that it remains valid for the current network conditions.

In a further embodiment, a network may use selection based solely on interference prediction, in which case it is not necessary for a node to include the RSSI 24 or to transmit an indication of the amount of interference it is experiencing. Dual schemes may be implemented which use a selection criterion using both measurements and predictions.

In a further embodiment, a network comprising a master node and a plurality of slave nodes performs route selection solely at the master station, in which case the master node need not include the RSSI 24, and the slave nodes need not include the storage means 60. For convenience in the present specification, a node equipped for route selection is referred to as a primary node and a route equipped for transmitting interference reports is referred to as a secondary node. A node may include both the primary and secondary node functionalities.

Optionally, means additional to the RSSI 24 may be used to measure an amount of interference, for example filtering may be used to measure interference within a specific bandwidth, or a timing circuit may be used to measure the duration of interference.

Optionally, route selection may take place during transmission of a message if the interference level changes.

Optionally, routes may be selected for more than one message simultaneously to ensure that the messages do not interfere with each other on the chosen routes.

Optionally, a route may be selected to avoid generating interference to another network.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communication and the art of wireless networking and which may be used instead of or in addition to features already described herein.

1. A method of selecting a route for a message in a wireless network comprising a plurality of nodes (A to F), the method comprising determining (50) for each of at least some of the nodes an indication of an amount of interference experienced by that node and selecting (50) a route having one or more nodes and which provides compliance of the indication of the amount of interference experienced by a subset of the nodes with a predetermined criterion.

2. A method as claimed in claim 1, wherein the subset of the nodes comprises the nodes of the selected route.

3. A method as claimed in claim 1, wherein the subset of the nodes comprises nodes outside of the selected route and the interference experienced by the subset of nodes is caused by transmission of the message via the selected route.

4. A method as claimed in claim 2, wherein determining an indication of an amount of interference comprises measuring the amount of interference.

5. A method as claimed in claim 2, wherein determining an indication of an amount of interference comprises predicting the amount of interference.

6. A primary node for use in a wireless network comprising a plurality of nodes, the primary node comprising a transceiver (10, 20) for transmitting and receiving messages, processing means (50) for encoding messages prior to transmission and for decoding received messages, storage means (60) for storing an indication of an amount of interference experienced by each of at least some of the nodes, and selection means (50) for selecting for a message prior to transmission a route having one or nodes and which provides compliance of the indication of the amount of interference experienced by a subset of the nodes with a predetermined criterion.

7. A primary node as claimed in claim 6, wherein the subset of the nodes comprises the nodes of the selected route.

8. A primary node as claimed in claim 6, wherein the subset of the nodes comprises the nodes outside of the selected route and the interference experienced by the subset of nodes is caused by transmission of the message via the selected route.

9. A primary node as claimed in claim 7, comprising means (20) for receiving the indication of an amount of interference experienced at a node and means (50) for transferring the indication to the storage means.

10. A primary node as claimed in claim 7, comprising means (50) for predicting an amount of interference experienced at a node, means (50) for determining from the predicted amount of interference an indication of the amount of interference, and means (50) for transferring the indication to the storage means.

11. A secondary node for use in a wireless network comprising a plurality of nodes, the secondary node comprising a transceiver (10, 20) for transmitting and receiving messages, processing means (50) for encoding messages prior to transmission and for decoding received messages, measurement means (24) for measuring an amount of interference and transmitter means (10) for transmitting an indication of the amount of interference.

12. A wireless network comprising at least one primary node as claimed in claim 6.

13. A wireless network as claimed in claim 12, comprising at least one secondary node for use in a wireless network comprising a plurality of nodes, the secondary node comprising a transceiver (10, 20) for transmitting and receiving messages, processing means (50) for encoding messages prior to transmission and for decoding received messages, measurement means (24) for measuring an amount of interference and transmitter means (10) for transmitting an indication of the amount of interference.
